(19) United States
(12) Patent Application Publication
(10) Pub. No.: US 2023/0076143 A1
(43) Pub. Date: Mar. 9, 2023

(54) TEXTURED GLASS-BASED ARTICLES

(71) Applicant: CORNING INCORPORATED, Corning, NY (US)

(72) Inventors: John Steele Abbott, III, Elmira, NY (US); Melanie Lian Geiger, Horseheads, NY (US); Yuhui Jin, Painted Post, NY (US); Aize Li, Painted Post, NY (US); Qiao Li, Horseheads, NY (US); Kevin Barry Reiman, Horseheads, NY (US); John Richard Ridge, Hammondsport, NY (US); Wei Sun, Painted Post, NY (US)

(21) Appl. No.: 17/893,329

(22) Filed: Aug. 23, 2022

Related U.S. Application Data
(60) Provisional application No. 63/236,925, filed on Aug. 25, 2021.

(51) Int. Cl. C03C 15/02; C03C 21/00

(52) U.S. Cl. CPC C03C 15/02; C03C 21/002

(57) ABSTRACT

A glass-based article with a textured surface exhibiting low haze is provided. The glass-based articles are produced by utilizing a combination of abrasion and etching, where hydrofluoric acid is not utilized. The process for producing the glass-based articles also includes an ion exchange process.

This application claims the benefit of priority of U.S. Provisional Application Ser. No. 63/236,925 filed on Aug. 25, 2021, the content of which is relied upon and incorporated herein by reference in its entirety.

### BACKGROUND

### Field

The present specification generally relates to textured glass-based articles. More specifically, the textured glass-based articles are useful in mobile electronic devices.

### Technical Background

Portable electronic devices, such as, smartphones, tablets, and wearable devices (such as, for example, watches and fitness trackers) continue to get smaller and more complex. As such, materials that are conventionally used on at least one external surface of such portable electronic devices also continue to get more complex. For instance, as portable electronic devices get smaller and thinner to meet consumer demand, the display covers and housings used in these portable electronic devices serve multiple functions and cover multiple components, such as a display, cameras, and sensors, each of which may require different surface properties for optimum functionality.

Accordingly, a need exists for materials with different surface properties, and methods of producing such materials.

### SUMMARY

According to aspect (1), a method is provided. The method comprises: abrading a surface of a glass-based substrate to form an abraded surface by propelling abrasive particles against the surface, wherein the glass-based substrate comprises an alkali aluminosilicate; etching the abraded surface with an etchant for a time period of greater than or equal to 15 minutes to less than or equal to 400 minutes to form an etched glass-based substrate, wherein the etchant is an aqueous hydroxide solution with a hydroxide concentration of greater than or equal to 5 wt % to less than or equal to 60 wt %; and ion exchanging the etched glass-based substrate with a molten salt bath to form a glass-based article, wherein the glass-based article comprises a compressive stress layer extending from a surface of the glass-based article to a depth of compression and has a haze of less than or equal to 50%.

According to aspect (2), the method of aspect (1) is provided, wherein the etching occurs at a surface removal rate of less than or equal to 60 μm/hour.

According to aspect (3), the method of any of aspect (1) to the preceding aspect is provided, wherein the etching occurs at a surface removal rate of less than or equal to 30 μm/hour.

According to aspect (4), the method of any of aspect (1) to the preceding aspect is provided, wherein the etchant is at a temperature of greater than or equal to 90° C. to less than or equal to 140° C.

According to aspect (5), the method of any of aspect (1) to the preceding aspect is provided, wherein the etchant is at a temperature of greater than or equal to 90° C. to less than or equal to 132° C.

According to aspect (6), the method of any of aspect (1) to the preceding aspect is provided, wherein the etchant comprises NaOH, KOH, or combinations thereof.

According to aspect (7), the method of any of aspect (1) to the preceding aspect is provided, wherein the etching time period is greater than or equal to 15 minutes to less than or equal to 300 minutes.

According to aspect (8), the method of any of aspect (1) to the preceding aspect is provided, wherein the etching removes greater than or equal to 5 μm to less than or equal to 50 μm from the abraded surface.

According to aspect (9), the method of any of aspect (1) to the preceding aspect is provided, wherein no mask is utilized during the etching.

According to aspect (10), the method of any of aspect (1) to the preceding aspect is provided, wherein the abrasive particles comprise sand, Al₂O₃, SiC, SiO₂, and combinations thereof.

According to aspect (11), the method of any of aspect (1) to the preceding aspect is provided, wherein the abrasive particles have a particle size of greater than or equal to 2000 grit to less than or equal to 200 grit.

According to aspect (12), the method of any of aspect (1) to the preceding aspect is provided, wherein the abrasive particles have a particle size of greater than or equal to 2000 grit to less than or equal to 1200 grit.

According to aspect (13), the method of any of aspect (1) to the preceding aspect is provided, wherein the abrasive particles are propelled by a fluid medium at a pressure of greater than or equal to 5 psi to less than or equal to 30 psi.

According to aspect (14), the method of any of aspect (1) to the preceding aspect is provided, wherein the abrasive particles are propelled from a nozzle at a distance from the surface of greater than or equal to 5 cm to less than or equal to 20 cm.

According to aspect (15), the method of any of aspect (1) to the preceding aspect is provided, wherein the abrasive particles are propelled against the surface at an angle from orthogonal to the surface of greater than or equal to 0° to less than or equal to 60°.

According to aspect (16), the method of any of aspect (1) to the preceding aspect is provided, wherein the abrading is repeated.

According to aspect (17), the method of any of aspect (1) to the preceding aspect is provided, wherein the molten salt bath comprises NaNO₃ and KNO₃.

According to aspect (18), the method of any of aspect (1) to the preceding aspect is provided, wherein the molten salt bath is at a temperature of greater than or equal to 350° C. to less than or equal to 500° C.

According to aspect (19), the method of any of aspect (1) to the preceding aspect is provided, wherein the ion exchanging extends for a time period of greater than or equal to 10 minutes to less than or equal to 500 minutes.

According to aspect (20), the method of any of aspect (1) to the preceding aspect is provided, wherein the ion exchanging extends for a time period of greater than or equal to 10 minutes to less than or equal to 300 minutes.

According to aspect (21), the method of any of aspect (1) to the preceding aspect is provided, wherein the glass-based article has a haze of greater than or equal to 3% to less than or equal to 40%.

According to aspect (22), the method of any of aspect (1) to the preceding aspect is provided, wherein the glass-based article has a distinctness of image of less than or equal to 92%.

According to aspect (23), the method of any of aspect (1) to the preceding aspect is provided, wherein the glass-based article has a pixel power deviation at 140 ppi of less than or equal to 5%.

According to aspect (24), the method of any of aspect (1) to the preceding aspect is provided, wherein the glass-based article has a gloss 60° value of less than or equal to 40%.

According to aspect (25), the method of any of aspect (1) to the preceding aspect is provided, wherein the glass-based article has a surface roughness Ra of greater than or equal to 100 nm to less than or equal to 400 nm.

According to aspect (26), the method of any of aspect (1) to the preceding aspect is provided, wherein the glass-based article has a compressive stress of greater than or equal to 200 MPa.

According to aspect (27), the method of any of aspect (1) to the preceding aspect is provided, wherein the glass-based article has a depth of compression of greater than or equal to 5 μm.

According to aspect (28), the method of any of aspect (1) to the preceding aspect is provided, wherein the glass-based article has a warp of less than or equal to 500 μm.

According to aspect (29), the method of any of aspect (1) to the preceding aspect is provided, wherein the glass-based article satisfies:

$$W \leq 0.5 \frac{{d}^{2}}{470321.6 {mm}^{2}}$$

wherein W is warp in mm, and d is a diagonal measurement of the glass-based article in mm.

According to aspect (30), the method of any of aspect (1) to the preceding aspect is provided, wherein the difference in warp between the glass-based article and the etched glass-based substrate is less than the warp of the etched glass-based substrate.

According to aspect (31), the method of any of aspect (1) to the preceding aspect is provided, wherein the glass-based substrate comprises a lithium aluminosilicate glass.

According to aspect (32), the method of any of aspect (1) to aspect (30) is provided, wherein the glass-based substrate is substantially free of lithium.

According to aspect (33), the method of any of aspect (1) to the preceding aspect is provided, wherein the glass-based substrate comprises a glass-ceramic.

According to aspect (34), the method of any of aspect (1) to the preceding aspect is provided, wherein the method does not employ hydrofluoric acid.

According to aspect (35), a glass-based article is provided. The glass-based article is produced according to any of the foregoing aspects.

According to aspect (36), a consumer electronic product is provided. The consumer electronic product, comprises: a housing having a front surface, a back surface and side surfaces; electrical components provided at least partially within the housing, the electrical components including at least a controller, a memory, and a display, the display being provided at or adjacent the front surface of the housing; and a cover substrate disposed over the display, wherein at least a portion of at least one of the housing and the cover substrate comprises the glass-based article of the aspect (35).

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, serve to explain the principles and operations of the claimed subject matter.

### BRIEF DESCRIPTION OF THE DRAWINGS

FIG. 1A is a plan view of an exemplary electronic device incorporating any of the glass-based articles disclosed herein;

FIG. 1B is a perspective view of the exemplary electronic device of FIG. 1A;

FIG. 2 is a schematic depiction of a cross-sectional view of a glass-based article having compressive stress layers on surfaces thereof according to embodiments disclosed and described herein;

FIG. 3 is bar graph depicting the etch rate for various glass-based substrates and etchant solutions;

FIG. 4A is plot of surface roughness as a function of etch removal amounts for glass-based articles according to embodiments, HF-etched articles, and control samples for a variety of sandblasting (SB) conditions;

FIG. 4B is a plot of haze as a function of surface roughness for glass-based articles according to embodiments, HF-etched articles, and control samples;

FIG. 4C is a plot of sparkle as a function of surface roughness for glass-based articles according to embodiments, HF-etched articles, and control samples;

FIG. 4D is a plot of distinctness of image (DOI) as a function of surface roughness for glass-based articles according to embodiments, HF-etched articles, and control samples;

FIG. 4E is a plot of Gloss 60° as a function of surface roughness for glass-based articles according to embodiments, HF-etched articles, and control samples;

FIG. 5A is a plot of haze as a function of etching surface double sided (DS) removal for glass-based articles according to embodiments and HF-etched articles;

FIG. 5B is a plot of surface roughness as a function of etching surface double sided (DS) removal for glass-based articles according to embodiments and HF-etched articles;

FIG. 6 are scanning electron micrographs of glass-based articles according to embodiments and HF-etched articles;

FIG. 7 is a Weibull plot of the ring-on-ring strength for glass-based articles according to embodiments, HF-etched articles, and control samples;

FIG. 8 is a schematic depiction of a ring-on-ring testing apparatus;

FIG. 9A is a plot of surface roughness for glass-based articles according to embodiments and HF-etched articles;

FIG. 9B is a plot of surface roughness for glass-based articles according to embodiments and HF-etched articles;

FIG. 9C is a plot of DOI for glass-based articles according to embodiments and HF-etched articles;

FIG. 9D is a plot of sparkle for glass-based articles according to embodiments and HF-etched articles;

FIG. 9E is a plot of clarity for glass-based articles according to embodiments and HF-etched articles;

FIG. 9F is a plot of diffusion for glass-based articles according to embodiments and HF-etched articles;

FIG. 9G is a plot of Gloss 60° for glass-based articles according to embodiments and HF-etched articles;

FIG. 10A is a plot of warp for ion exchanged glass-based articles according to embodiments and HF-etched articles; and

FIG. 10B is a plot of warp for low central tension (CT) ion exchanged glass-based articles according to embodiments and HF-etched articles.

### DETAILED DESCRIPTION

Reference will now be made in detail to textured glass-based articles according to various embodiments. In particular, the textured glass-based articles are suitable for use as display covers and/or housings in portable electronic devices. The textured glass-based articles may be produced without the use of hydrofluoric acid.

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. Whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

Unless otherwise specified, all compositions of the glasses described herein are expressed in terms of mole percent (mol %), and the constituents are provided on an oxide basis. Unless otherwise specified, all temperatures are expressed in terms of degrees Celsius (° C.). All ranges disclosed in this specification include any and all ranges and subranges encompassed by the broadly disclosed ranges whether or not explicitly stated before or after a range is disclosed.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. As utilized herein, when the term “about” is used to modify a value, the exact value is also disclosed.

The textured articles described herein are glass-based. As utilized herein, the term “glass-based” refers to any article that includes glass, such as a glass or glass-ceramic material. For example, a glass-based article may be a laminated material where at least one laminate layer includes a glass or glass-ceramic.

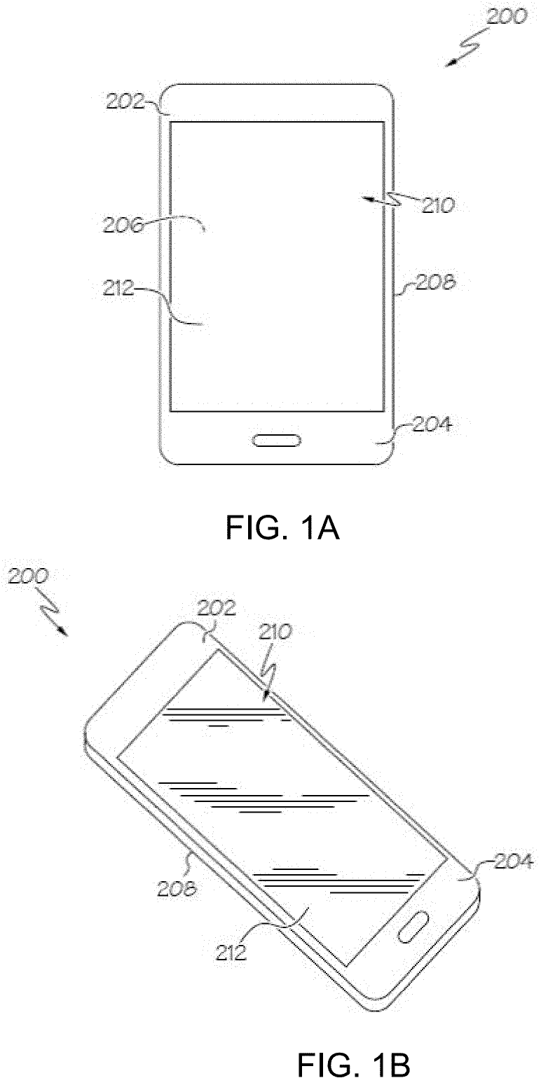

The textured glass-based articles disclosed herein, in as-formed or ion exchanged form, may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, or any article that may benefit from some transparency, scratch-resistance, abrasion resistance or a combination thereof. An exemplary article incorporating any of the glass-based articles disclosed herein is shown in FIGS. 1A and 1B. Specifically, FIGS. 1A and 1B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and/or the housing 202 may include any of the glass-based articles disclosed herein.

As described above, the textured glass-based articles described herein can be used as a front or back cover for mobile electronic devices. The glass-based articles not only serve as protective covers but also serve to enable various functionalities of the mobile electronic devices. For example, the textured glass-based articles may possess desirable antiglare properties which improve display readability in the presence of strong ambient light conditions, may improve the touch feel, and may also provide a desirable aesthetic appearance.

Textured glass-based articles may be produced utilizing a variety of processes, such as wet chemical etching techniques and abrasion combined with etching techniques. The low haze glass-based articles suitable for use as display covers may be produced by techniques that combine sandblasting and hydrofluoric (HF) acid etching processes. However, the use of hydrofluoric acid presents significant safety and environmental challenges. Alternative techniques, such as those that do not employ HF acid etching have previously exhibited long manufacturing times (slow manufacturing throughput) and/or inferior surface, optical, and mechanical properties.

The processes described herein are capable of producing glass-based articles with surface, optical, and mechanical properties equivalent to those produced by an HF acid etching process while also exhibiting a desirable manufacturing throughput capability. The processes is relatively fast and produces a substantially uniform surface. In addition, the processes described herein do not utilize HF acid, and thereby avoid the safety and environmental risks associated with HF acid.

The processes for producing the textured glass-based articles will now be described in detail. The processes include an abrasion step, an etching step, and an ion exchange step. The abrasion step includes abrading a surface of a glass-based substrate by propelling abrasive particles against the surface to form an abraded surface. The etching step includes etching the abraded surface with an etchant to form an etched glass-based substrate. The ion exchanging step includes ion exchanging the etched glass-based substrate with a molten salt bath to form a glass-based article that includes a compressive stress layer extending from a surface thereof to a depth of compression. The process produces glass-based articles with a haze of less than or equal to 50%, such as less than or equal to 40%. The characteristics of the glass-based articles produced by the methods described herein may be any of those detailed below.

The abrasion and etching may be applied to the entirety of the surface of the glass-based substrate, producing an etched glass-based substrate with a substantially uniform surface texture. In embodiments, the process does not employ a mask on the surface of the glass-based substrate. Alternatively, the abrading and/or etching may be applied to only a portion of the surface of the glass-based substrate, such that the etched glass-based substrate includes at least one non-textured surface region. Where the abrading and/or etching is conducted on only a portion of the surface of the glass-based substrate a mask may be utilized on the surface of the glass-based substrate during the abrading and/or etching.

In embodiments, the abrasion process may be a particulate blasting process, commonly referred to as media blasting or sand blasting, in which abrasive particles are propelled against the surface of the glass-based substrate by a pressurized fluid medium. The abrasion process may include one or more treatments of the surface. In embodiments, the abrasion process may be repeated one or more times to achieve the desired effect.

The abrasion process may employ any appropriate abrasive particles. In embodiments, the abrasive particles may include sand, Al₂O₃, SiC, SiO₂, and combinations thereof. The abrasive particles may have a particle size selected to produce the desired abrading effect. In embodiments, the abrasive particles have a particle size greater than or equal to 2000 grit to less than or equal to 200 grit, such as greater than or equal to 1900 grit to less than or equal to 200 grit, greater than or equal to 1800 grit to less than or equal to 200 grit, greater than or equal to 1700 grit to less than or equal to 200 grit, greater than or equal to 1600 grit to less than or equal to 200 grit, greater than or equal to 1500 grit to less than or equal to 200 grit, greater than or equal to 1400 grit to less than or equal to 300 grit, greater than or equal to 1300 grit to less than or equal to 400 grit, greater than or equal to 1200 grit to less than or equal to 500 grit, greater than or equal to 1100 grit to less than or equal to 600 grit, greater than or equal to 1000 grit to less than or equal to 700 grit, greater than or equal to 900 grit to less than or equal to 800 grit, greater than or equal to 1200 grit to less than or equal to 200 grit, greater than or equal to 2000 grit to less than or equal to 1200 grit, and any and all sub-ranges formed from any of the foregoing endpoints.

The abrasion process may employ any appropriate pressure and nozzle arrangement. In embodiments, the abrasive particles may be propelled by a fluid medium at a pressure greater than or equal to 5 psi to less than or equal to 30 psi, such as greater than or equal to 6 psi to less than or equal to 29 psi, greater than or equal to 7 psi to less than or equal to 28 psi, greater than or equal to 8 psi to less than or equal to 27 psi, greater than or equal to 9 psi to less than or equal to 26 psi, greater than or equal to 10 psi to less than or equal to 25 psi, greater than or equal to 11 psi to less than or equal to 24 psi, greater than or equal to 12 psi to less than or equal to 23 psi, greater than or equal to 13 psi to less than or equal to 22 psi, greater than or equal to 14 psi to less than or equal to 21 psi, greater than or equal to 15 psi to less than or equal to 20 psi, greater than or equal to 16 psi to less than or equal to 19 psi, greater than or equal to 17 psi to less than or equal to 18 psi, and any and all sub-ranges formed from any of the foregoing endpoints. In embodiments, the fluid medium propelling the abrasive particles is air. In embodiments, the abrasive particles are propelled from a nozzle at a distance from the surface of greater than or equal to 5 cm to less than or equal to 20 cm, such as greater than or equal to 6 cm to less than or equal to 19 cm, greater than or equal to 7 cm to less than or equal to 18 cm, greater than or equal to 8 cm to less than or equal to 17 cm, greater than or equal to 9 cm to less than or equal to 16 cm, greater than or equal to 10 cm to less than or equal to 15 cm, greater than or equal to 11 cm to less than or equal to 14 cm, greater than or equal to 12 cm to less than or equal to 13 cm, and any and all sub-ranges formed from any of the foregoing endpoints. The nozzle may be positioned such that the abrasive particles are propelled against the surface of the glass-based substrate at any angle from orthogonal to the surface, wherein an angle of 0° indicates that the abrasive particles are propelled along a path orthogonal to the surface. In embodiments, the abrasive particles are propelled against the surface of the glass-based substrate at any angle from orthogonal to the surface of greater than or equal to 0° to less than or equal to 60°, such as greater than or equal to 5° to less than or equal to 55°, greater than or equal to 10° to less than or equal to 50°, greater than or equal to 15° to less than or equal to 45°, greater than or equal to 20° to less than or equal to 40°, greater than or equal to 25° to less than or equal to 35°, greater than or equal to 0° to less than or equal to 30°, and any and all sub-ranges formed from any of the foregoing endpoints.

The etching process may be selected to achieve a surface removal rate that provides the desired etching speed. The surface removal rate may also be referred to herein as the etching rate. In general, faster etching rates are desired, as fast etching rates increase manufacturing throughput. However, when an etching rate is too high surface uniformity may be reduced and cosmetic defects may develop. The etching rate is a function of the etchant and the composition of the glass-based substrate. In embodiments, the etching occurs at a surface removal rate of less than or equal to 60 μm/hour, such as less than or equal to 55 μm/hour, less than or equal to 50 μm/hour, less than or equal to 45 μm/hour, less than or equal to 40 μm/hour, less than or equal to 35 μm/hour, less than or equal to 30 μm/hour, less than or equal to 25 μm/hour, less than or equal to 20 μm/hour, less than or equal to 15 μm/hour, less than or equal to 10 μm/hour, less than or equal to 9.5 μm/hour, less than or equal to 9 μm/hour, less than or equal to 8.5 μm/hour, less than or equal to 8 μm/hour, less than or equal to 7.5 μm/hour, less than or equal to 7 μm/hour, less than or equal to 6.5 μm/hour, less than or equal to 6 μm/hour, less than or equal to 5.5 μm/hour, less than or equal to 5 μm/hour, or less.

The etching process is conducted for a time period sufficient to produce the desired surface properties, such as haze. In embodiments, the glass-based substrate is contacted with the etchant for a time period of greater than or equal to 15 minutes to less than or equal to 400 minutes, such as greater than or equal to 30 minutes to less than or equal to 400 minutes, greater than or equal to 15 minutes to less than or equal to 300 minutes, greater than or equal to 20 minutes to less than or equal to 300 minutes, greater than or equal to 25 minutes to less than or equal to 300 minutes, greater than or equal to 30 minutes to less than or equal to 300 minutes, greater than or equal to 40 minutes to less than or equal to 390 minutes, greater than or equal to 50 minutes to less than or equal to 380 minutes, greater than or equal to 60 minutes to less than or equal to 370 minutes, greater than or equal to 70 minutes to less than or equal to 360 minutes, greater than or equal to 80 minutes to less than or equal to 350 minutes, greater than or equal to 90 minutes to less than or equal to 340 minutes, greater than or equal to 100 minutes to less than or equal to 330 minutes, greater than or equal to 110 minutes to less than or equal to 320 minutes, greater than or equal to 120 minutes to less than or equal to 310 minutes, greater than or equal to 130 minutes to less than or equal to 300 minutes, greater than or equal to 140 minutes to less than or equal to 290 minutes, greater than or equal to 150 minutes to less than or equal to 280 minutes, greater than or equal to 160 minutes to less than or equal to 270 minutes, greater than or equal to 170 minutes to less than or equal to 260 minutes, greater than or equal to 180 minutes to less than or equal to 250 minutes, greater than or equal to 190 minutes to less than or equal to 240 minutes, greater than or equal to 200 minutes to less than or equal to 230 minutes, greater than or equal to 210 minutes to less than or equal to 220 minutes, and any and all sub-ranges formed from any of the foregoing endpoints.

The etchant may have any appropriate composition. In embodiments, the etchant is an aqueous hydroxide solution with a hydroxide concentration of greater than or equal to 5 wt % to less than or equal to 60 wt %, such as greater than or equal to 5 wt % to less than or equal to 55 wt %, greater than or equal to 5 wt % to less than or equal to 50 wt %, greater than or equal to 10 wt % to less than or equal to 45 wt %, greater than or equal to 15 wt % to less than or equal to 40 wt %, greater than or equal to 20 wt % to less than or equal to 35 wt %, greater than or equal to 25 wt % to less than or equal to 30 wt %, and any and all sub-ranges formed from any of the foregoing endpoints. In embodiments, the etchant includes NaOH, KOH, or combinations thereof. The etchant may be substantially free or free of hydrofluoric acid. In embodiments, the glass-based articles described herein are produced without employing hydrofluoric acid.

The etchant may be at an elevated temperature during the etching process. The elevated temperature may increase the etching rate. In embodiments, the etchant is at a temperature of greater than or equal to 90° C. to less than or equal to 140° C., such as greater than or equal to 90° C. to less than or equal to 132° C., greater than or equal to 95° C. to less than or equal to 135° C., greater than or equal to 100° C. to less than or equal to 130° C., greater than or equal to 105° C. to less than or equal to 125° C., greater than or equal to 110° C. to less than or equal to 120° C., greater than or equal to 90° C. to less than or equal to 115° C., and any and all sub-ranges formed from the foregoing endpoints.

The etching rate and etching time may be selected to remove a desired amount of material from the surface of the glass-based substrate. If the amount of material removed in the etching step is too low the desired surface properties, such as haze, may not be achieved. Removing too much material from the abraded surface may increase cost and reduce manufacturing throughput. In embodiments, the etching process removes greater than or equal to 5 μm to less than or equal to 50 μm from the abraded surface, such as greater than or equal to 10 μm to less than or equal to 45 μm, greater than or equal to 15 μm to less than or equal to 40 μm, greater than or equal to 20 μm to less than or equal to 35 μm, greater than or equal to 25 μm to less than or equal to 30 μm, and any and all ranges formed from the foregoing endpoints. The amount of material removed from the abraded surface is measured in the thickness direction of the glass-based article by micrometer unless otherwise indicated.

In embodiments, the abrasion and etching processes described herein may be performed on only one surface of the glass-based substrate. In such embodiments, at least one surface of the textured glass-based article retains its characteristics as formed.

The glass-based substrates utilized to form the textured glass-based articles may have any suitable composition. The composition of the glass-based substrates influences the etching rate, as illustrated in the examples described herein. Selecting glass-based substrates that exhibit fast etch rates increases manufacturing throughput.

In embodiments, the glass-based substrates may include a glass ceramic. Exemplary glass ceramic materials are those described in U.S. Patent App. Pub. No. 2016/0102010 A1, titled “High Strength Glass-Ceramics Having Petalite and Lithium Silicate Structures,” published Apr. 14, 2016, the contents of which are incorporated herein by reference in their entirety.

In embodiments, the glass-based substrates may include an alkali aluminosilicate glass, such as a lithium aluminosilicate glass. Exemplary lithium aluminosilicate glass materials are those described in U.S. Patent App. Pub. No. 2019/0300422 A1, titled “Glasses Having High Fracture Toughness,” published Oct. 3, 2019, the contents of which are incorporated herein by reference in their entirety.

In embodiments, the glass-based substrates may include an alkali aluminosilicate that is substantially free or free of lithium. Exemplary alkali aluminosilicate glass materials that are substantially-free or free of lithium are those described in U.S. Patent App. Pub. No. 2009/0142568 A1, titled “Glasses Having Improved Toughness and Scratch Resistance,” published Jun. 4, 2009, U.S. Patent App. Pub. No. 2009/0142568 A1, titled “Glasses Having Improved Toughness and Scratch Resistance,” published Jun. 4, 2009; U.S. Patent App. Pub. No. 2014/0227523 A1, titled “Zircon Compatible, Ion Exchangeable Glass With High Damage Resistance,” published Aug. 14, 2014; and U.S. Patent App. Pub. No. 2011/0201490 A1, titled “Crack And Scratch Resistant Glass And Enclosures Made Therefrom,” published Aug. 18, 2011, the contents of each of which are incorporated herein by reference in their entirety.

The glass-based articles produced by the methods described herein are chemically strengthened, such as by ion exchange. Such chemically strengthened glass-based articles exhibit improved damage resistant for applications such as, but not limited to, display covers. The chemical strengthening of the glass-based articles increases the strength of the glass-based articles.

In the ion exchange treatment, the etched glass-based substrate is contacted with a molten salt bath to produce the ion-exchanged glass-based article. In embodiments, the etched glass-based substrate may be submerged in the molten salt bath. In embodiments, the molten salt bath includes a molten nitrate salt. The molten nitrate salt may include KNO₃, NaNO₃, or combinations thereof. In embodiments, the molten salt bath comprises NaNO₃ and KNO₃. The molten salt bath may additionally include silicic acid.

The etched glass-based substrate may be exposed to the molten salt bath by dipping the etched glass-based substrate into the molten salt bath. Upon exposure to the etched glass-based substrate, the molten salt bath may, according to embodiments, be at a temperature of greater than or equal to 350° C. to less than or equal to 500° C., such as greater than or equal to 360° C. to less than or equal to 490° C., greater than or equal to 370° C. to less than or equal to 480° C., greater than or equal to 390° C. to less than or equal to 470° C., greater than or equal to 400° C. to less than or equal to 460° C., greater than or equal to 410° C. to less than or equal to 450° C., greater than or equal to 420° C. to less than or equal to 440° C., greater than or equal to 350° C. to less than or equal to 430° C., and any and all sub-ranges formed from any of the foregoing endpoints.

The ion exchange treatment may continue for any time period sufficient to produce the desired stress characteristics in the glass-based article. In embodiments, the etched glass-based substrate may be exposed to the molten salt bath for a time period greater than or equal to 10 minutes to less than or equal to 500 minutes, such as greater than or equal to 10 minutes to less than or equal to 300 minutes, greater than or equal to 20 minutes to less than or equal to 490 minutes, greater than or equal to 30 minutes to less than or equal to 480 minutes, greater than or equal to 40 minutes to less than or equal to 470 minutes, greater than or equal to 50 minutes to less than or equal to 460 minutes, greater than or equal to 60 minutes to less than or equal to 450 minutes, greater than or equal to 70 minutes to less than or equal to 440 minutes, greater than or equal to 80 minutes to less than or equal to 430 minutes, greater than or equal to 90 minutes to less than or equal to 420 minutes, greater than or equal to 100 minutes to less than or equal to 410 minutes, greater than or equal to 110 minutes to less than or equal to 400 minutes, greater than or equal to 120 minutes to less than or equal to 390 minutes, greater than or equal to 130 minutes to less than or equal to 380 minutes, greater than or equal to 140 minutes to less than or equal to 370 minutes, greater than or equal to 150 minutes to less than or equal to 360 minutes, greater than or equal to 160 minutes to less than or equal to 350 minutes, greater than or equal to 170 minutes to less than or equal to 340 minutes, greater than or equal to 180 minutes to less than or equal to 330 minutes, greater than or equal to 190 minutes to less than or equal to 320 minutes, greater than or equal to 200 minutes to less than or equal to 310 minutes, greater than or equal to 210 minutes to less than or equal to 300 minutes, greater than or equal to 220 minutes to less than or equal to 290 minutes, greater than or equal to 230 minutes to less than or equal to 280 minutes, greater than or equal to 240 minutes to less than or equal to 270 minutes, greater than or equal to 250 minutes to less than or equal to 260 minutes, and any and all sub-ranges formed from any of the foregoing endpoints.

The properties of the glass-based articles will now be described in detail. The glass-based articles are characterized by a haze level, and may also be characterized by a surface roughness, distinctness of image, pixel power deviation, gloss 60° value, compressive stress, depth of compression, and warp.

The haze of the glass-based article is relatively low and may provide desirable optical properties and a pleasing aesthetic appearance. For example, the haze of the glass-based article provides an antiglare capability that improves performance in high ambient light conditions, such as bright sunlight. In embodiments, the haze is less than or equal to 50%, such as less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, or less. In embodiments, the haze is greater than or equal to 3% to less than or equal to 50%, such as greater than or equal to 3% to less than or equal to 45%, greater than or equal to 3% to less than or equal to 40%, greater than or equal to 5% to less than or equal to 35%, greater than or equal to 10% to less than or equal to 30%, greater than or equal to 15% to less than or equal to 25%, greater than or equal to 20% to less than or equal to 40%, and any and all sub-ranges formed between any of the foregoing endpoints. As used herein, haze refers to “transmittance haze,” and is measured using a Haze-gard Transparency Transmission Haze Meter, according to ASTM D1003 “Standard Test Method for Haze and Luminous Transmittance of Transparent Plastics” using Illuminant C.

The glass-based articles may have any surface roughness sufficient to produce the desired haze level. The surface roughness also provides the glass-based articles with a pleasing touch feel. In embodiments, the glass-based articles have a surface roughness greater than or equal to 100 nm to less than or equal to 400 nm, such as greater than or equal to 110 nm to less than or equal to 390 nm, greater than or equal to 120 nm to less than or equal to 380 nm, greater than or equal to 130 nm to less than or equal to 370 nm, greater than or equal to 140 nm to less than or equal to 360 nm, greater than or equal to 150 nm to less than or equal to 350 nm, greater than or equal to 160 nm to less than or equal to 340 nm, greater than or equal to 170 nm to less than or equal to 330 nm, greater than or equal to 180 nm to less than or equal to 320 nm, greater than or equal to 190 nm to less than or equal to 310 nm, greater than or equal to 200 nm to less than or equal to 300 nm, greater than or equal to 210 nm to less than or equal to 290 nm, greater than or equal to 220 nm to less than or equal to 280 nm, greater than or equal to 230 nm to less than or equal to 270 nm, greater than or equal to 240 nm to less than or equal to 260 nm, greater than or equal to 250 nm to less than or equal to 400 nm, and any and all sub-ranges formed from any of the foregoing endpoints. As used herein, unless otherwise specified, “surface roughness” refers to Rₐ, the arithmetical mean deviation of a measured profile. Unless otherwise specified, Rₐ is measured on a Zygo 7000 with the following settings: Scan size was 180 microns by 220 microns; Objective: 20× Mirau; Image Zoom 2×; Camera resolution 0.2777 microns; Filter: low Pass; Filter Type: Average; Filter Low Wavelength 0; Filter High Wavelength: 0.83169 microns.

The glass-based articles may be characterized by a gloss value, such as a gloss 60° value. In embodiments, the glass-based articles have a gloss 60° value of less than or equal to 40%, such as less than or equal to 35%, less than or equal to 30%, less than or equal to 25%, less than or equal to 20%, less than or equal to 15%, or less. In embodiments, the glass-based articles have a gloss 60° value of greater than or equal to 10% to less than or equal to 40%, such as greater than or equal to 15% to less than or equal to 35%, greater than or equal to 20% to less than or equal to 30%, greater than or equal to 25% to less than or equal to 40%, greater than or equal to 15% to less than or equal to 40%, and any and all sub-ranges formed from any of the foregoing endpoints. Gloss 60° or gloss 60 refers to a measurement taken at 60° from vertical using a Rhopoint Gloss Meter.

The glass-based articles may be characterized by a distinctness of image (DOI) value. In embodiments, the glass-based articles have a DOI of less than or equal to 92%, such as less than or equal to 91%, less than or equal to 90%, less than or equal to 89%, less than or equal to 90%, less than or equal to 89%, less than or equal to 88%, less than or equal to 87%, less than or equal to 86%, less than or equal to 85%, less than or equal to 84%, less than or equal to 83%, less than or equal to 82%, less than or equal to 81%, less than or equal to 80%, less than or equal to 79%, or less. In embodiments, the glass-based articles have a DOI of greater than or equal to 75% to less than or equal to 92%, such as greater than or equal to 76% to less than or equal to 91%, greater than or equal to 77% to less than or equal to 90%, greater than or equal to 78% to less than or equal to 89%, greater than or equal to 79% to less than or equal to 88%, greater than or equal to 80% to less than or equal to 87%, greater than or equal to 81% to less than or equal to 86%, greater than or equal to 82% to less than or equal to 85%, greater than or equal to 83% to less than or equal to 84%, and any and all sub-ranges formed from any of the foregoing endpoints. Unless otherwise specified, the distinctness of image is measured with a commercially available Rhopoint Gloss Meter.

The glass-based articles may be characterized by a sparkle effect when utilized with a display. The sparkle effect may be quantified by a pixel power deviation (PPD) measurement. The PPD measurement is dependent on the pixels per inch (ppi) value of the display utilized to perform the measurement. The PPD measurements were performed with a SMS-1000 Sparkle Measurement System, with the display utilized in the measurement being 140 ppi. In embodiments, the glass-based article has a PPD at 140 ppi of less than or equal to 5%, such as less than or equal to 5.0%, less than or equal to 4.9%, less than or equal to 4.8%, less than or equal to 4.7%, less than or equal to 4.6%, less than or equal to 4.5%, less than or equal to 4.4%, less than or equal to 4.3%, less than or equal to 4.2%, less than or equal to 4.1%, less than or equal to 4.0%, less than or equal to 4%, less than or equal to 3.9%, less than or equal to 3.8%, less than or equal to 3.7%, less than or equal to 3.6%, less than or equal to 3.5%, less than or equal to 3.4%, less than or equal to 3.3%, less than or equal to 3.2%, less than or equal to 3.1%, less than or equal to 3.0%, less than or equal to 3%, less than or equal to 2.9%, less than or equal to 2.8%, less than or equal to 2.7%, less than or equal to 2.6%, less than or equal to 2.5%, or less. In embodiments, the glass-based article has a PPD at 140 ppi of greater than or equal to 2% to less than or equal to 5%, such as greater than or equal to 3% to less than or equal to 4%, greater than or equal to 2.0% to less than or equal to 5.0%, greater than or equal to 2.1% to less than or equal to 4.9%, greater than or equal to 2.2% to less than or equal to 4.8%, greater than or equal to 2.3% to less than or equal to 4.7%, greater than or equal to 2.4% to less than or equal to 4.6%, greater than or equal to 2.5% to less than or equal to 4.5%, greater than or equal to 2.6% to less than or equal to 4.4%, greater than or equal to 2.7% to less than or equal to 4.3%, greater than or equal to 2.8% to less than or equal to 4.2%, greater than or equal to 2.9% to less than or equal to 4.1%, greater than or equal to 3.0% to less than or equal to 4.0%, greater than or equal to 3.1% to less than or equal to 3.9%, greater than or equal to 3.2% to less than or equal to 3.8%, greater than or equal to 3.3% to less than or equal to 3.7%, greater than or equal to 3.4% to less than or equal to 3.6%, greater than or equal to 3.5% to less than or equal to 4.0%, and any and all sub-ranges formed from any of the foregoing endpoints.

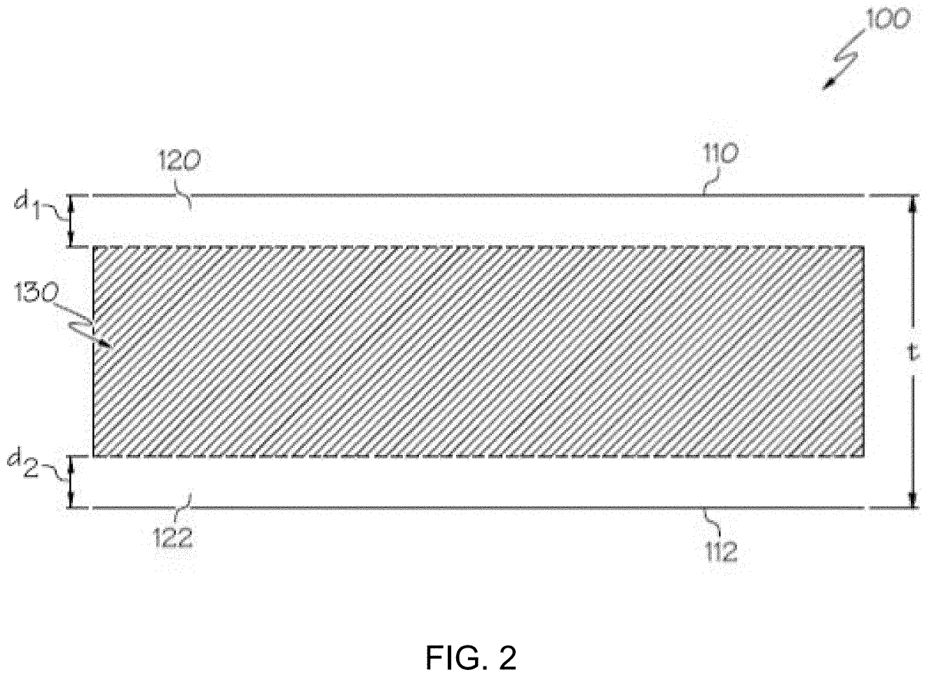

The glass-based article includes a compressive stress layer extending from the surface thereof to a depth of compression. With reference to FIG. 2, the strengthened glass-based article has a first region under compressive stress (e.g., first and second compressive layers 120, 122 in FIG. 2) extending from the surface to a depth of compression (DOC) of the strengthened glass-based article and a second region (e.g., central region 130 in FIG. 2) under a tensile stress or central tension (CT) extending from the DOC into the central or interior region of the glass-based article. As used herein, DOC refers to the depth at which the stress within the strengthened glass-based article changes from compressive to tensile. At the DOC, the stress crosses from a positive (compressive) stress to a negative (tensile) stress and thus exhibits a stress value of zero.

According to the convention normally used in the art, compression or compressive stress is expressed as a negative (<0) stress and tension or tensile stress is expressed as a positive (>0) stress. Throughout this description, however, CS is expressed as a positive or absolute value—i.e., as recited herein, CS=|CS|. The compressive stress (CS) may have a maximum at the surface of the strengthened glass-based article, and the CS may vary with distance d from the surface according to a function. Referring again to FIG. 2, a first compressive layer 120 extends from first surface 110 to a depth d₁ and a second compressive layer 122 extends from second surface 112 to a depth dz. Compressive stress (including surface CS) is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the strengthened glass-based article. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

The compressive stress of both compressive stress regions (120, 122 in FIG. 2) is balanced by stored tension in the central region (130) of the strengthened glass-based article. The maximum central tension (CT) and DOC values are measured using a scattered light polariscope (SCALP) technique known in the art.

The glass-based article may have any appropriate depth of compression. In embodiments, the depth of compression is greater than or equal to 5 μm, such as greater than or equal to 10 μm, greater than or equal to 15 μm, greater than or equal to 20 μm, greater than or equal to 25 μm, greater than or equal to 30 μm, greater than or equal to 35 μm, greater than or equal to 40 μm, greater than or equal to 45 μm, greater than or equal to 50 μm, greater than or equal to 55 μm, or more. In embodiments, the depth of compression is greater than or equal to 5 μm to less than or equal to 200 μm, such as greater than or equal to 10 μm to less than or equal to 190 μm, greater than or equal to 20 μm to less than or equal to 175 μm, greater than or equal to 25 μm to less than or equal to 150 μm, greater than or equal to 30 μm to less than or equal to 125 μm, greater than or equal to 35 μm to less than or equal to 100 μm, greater than or equal to 50 μm to less than or equal to 75 μm, and any and all sub-ranges formed from any of the foregoing endpoints.

The depth of compression of the glass-based article may also be characterized as a function of the thickness (t) of the glass-based article. In embodiments, the depth of compression is greater than or equal to 0.1t, such as greater than or equal to 0.2t, greater than or equal to 0.3t, greater than or equal to 0.4t, greater than or equal to 0.5t, greater than or equal to 0.6t, greater than or equal to 0.7t, greater than or equal to 0.8t, greater than or equal to 0.9t, greater than or equal to 0.10t, greater than or equal to 0.11t, greater than or equal to 0.12t, greater than or equal to 0.13t, greater than or equal to 0.14t, greater than or equal to 0.15t, greater than or equal to 0.16t, greater than or equal to 0.17t, greater than or equal to 0.18t, greater than or equal to 0.19t, greater than or equal to 0.20t, greater than or equal to 0.21t, or more. In embodiments, the depth of compression is greater than or equal to 0.1t to less than or equal to 0.25t, such as greater than or equal to 0.2t to less than or equal to 0.21t, greater than or equal to 0.3t to less than or equal to 0.20t, greater than or equal to 0.4t to less than or equal to 0.19t, greater than or equal to 0.5t to less than or equal to 0.18t, greater than or equal to 0.6t to less than or equal to 0.17t, greater than or equal to 0.7t to less than or equal to 0.16t, greater than or equal to 0.8t to less than or equal to 0.15t, greater than or equal to 0.9t to less than or equal to 0.14t, greater than or equal to 0.10t to less than or equal to 0.13t, greater than or equal to 0.11t to less than or equal to 0.12t, and any and all sub-ranges formed from any of the foregoing endpoints.

The compressive stress layer of the glass-based article includes a maximum compressive stress. In embodiments, the maximum compressive stress is greater than or equal to 200 MPa, such as greater than or equal to 250 MPa, greater than or equal to 300 MPa, greater than or equal to 350 MPa, greater than or equal to 400 MPa, greater than or equal to 450 MPa, greater than or equal to 500 MPa, greater than or equal to 550 MPa, greater than or equal to 600 MPa, or more. In embodiments, the maximum compressive stress is greater than or equal to 200 MPa to less than or equal to 1000 MPa, such as greater than or equal to 250 MPa to less than or equal to 950 MPa, greater than or equal to 300 MPa to less than or equal to 900 MPa, greater than or equal to 350 MPa to less than or equal to 850 MPa, greater than or equal to 400 MPa to less than or equal to 800 MPa, greater than or equal to 450 MPa to less than or equal to 750 MPa, greater than or equal to 500 MPa to less than or equal to 700 MPa, greater than or equal to 550 MPa to less than or equal to 650 MPa, greater than or equal to 500 MPa to less than or equal to 600 MPa, and any and all sub-ranges formed from any of the foregoing endpoints.

The ion exchange process may induce warp in the glass-based articles. Warp may be problematic when it exceeds a designated tolerance, rendering the glass-based articles unsuitable for their intended purposed. The warp is measured as the total instrument readout (TIR), the difference between the maximum and minimum height, across a major surface of the glass-based articles along a diagonal as reported by a Flat Master 200 commercially available device. The diagonal as utilized for the warp measurement is the diagonal between two corners for rectangular parts, for non-rectangular parts the diagonal refers to the longest possible distance along the major surface of the part. In embodiments, the glass-based articles have a warp of less than or equal to 500 μm, such as less than or equal to 475 μm, less than or equal to 450 μm, less than or equal to 425 μm, less than or equal to 400 μm, less than or equal to 375 μm, less than or equal to 350 μm, less than or equal to 325 μm, less than or equal to 300 μm, less than or equal to 275 μm, less than or equal to 250 μm, less than or equal to 225 μm, less than or equal to 200 μm, less than or equal to 175 μm, less than or equal to 150 μm, less than or equal to 125 μm, less than or equal to 100 μm, less than or equal to 75 μm, less than or equal to 50 μm, less than or equal to 25 μm, or less.

The warp may be related to the diagonal measurement of the glass-based articles. For example, a higher amount of warp may be acceptable for glass-based articles with larger diagonal measurements. In embodiments, the glass-based articles have a warp (W) in mm wherein:

$$W \leq 0.5 \frac{{d}^{2}}{470321.6 {mm}^{2}}$$

where d is the diagonal measurement of the glass-based article. In embodiments, a glass-based article with a diagonal measurement of 27 inches has a warp of less than or equal to 500 μm.

The warp may also be described in terms of the additional warp produced by the ion exchange treatment that produces the glass-based articles. In embodiments, the difference in warp between the glass-based article and the etched glass-based substrate subjected to ion exchange treatment to form the glass-based article is less than the warp of the glass-based substrate. Such a relationship ensures that the warp of the glass-based articles is primarily due to the forming process of the etched glass-based substrate, as opposed to the ion exchange process.

### EXAMPLES

Embodiments will be further clarified by the following examples. It should be understood that these examples are not limiting to the embodiments described above.

### Example 1

The etch rate of various glass-based substrates was investigated. Glass-based substrates having a thickness of 0.8 mm with the compositions of Table I were produced. All of the glass-based substrates are glass, except for Composition E which is a glass ceramic including a petalite crystal phase.

TABLE I

| Com- | | | | | |
|---|---|---|---|---|---|
| position | A | B | C | D | E |
| SiO₂ | 67.4 | 64.6 | 63.6 | 58.4 | 71.5 |
| B₂O₃ | 3.7 | 5.1 | 2.3 | 6.1 | 0.0 |
| Al₂O₃ | 12.7 | 14.0 | 15.1 | 17.8 | 4.3 |
| Na₂O | 13.8 | 13.8 | 9.3 | 1.7 | 0.1 |
| K₂O | 0.0 | 0.0 | 0.0 | 0.2 | 0.1 |
| Li₂O | 0.0 | 0.0 | 5.9 | 10.7 | 21.9 |
| MgO | 2.4 | 2.4 | 0.0 | 4.4 | 0.0 |
| ZnO | 0.0 | 0.0 | 1.2 | 0.0 | 0.0 |
| TiO₂ | 0.0 | 0.0 | 0.0 | 0.0 | 0.0 |
| CaO | 0.0 | 0.0 | 0.0 | 0.6 | 0.0 |
| ZrO₂ | 0.0 | 0.0 | 0.0 | 0.0 | 2.0 |
| SnO₂ | 0.1 | 0.1 | 0.0 | 0.1 | 0.2 |
| P₂O₅ | 0.0 | 0.0 | 2.5 | 0.0 | 0.4 |

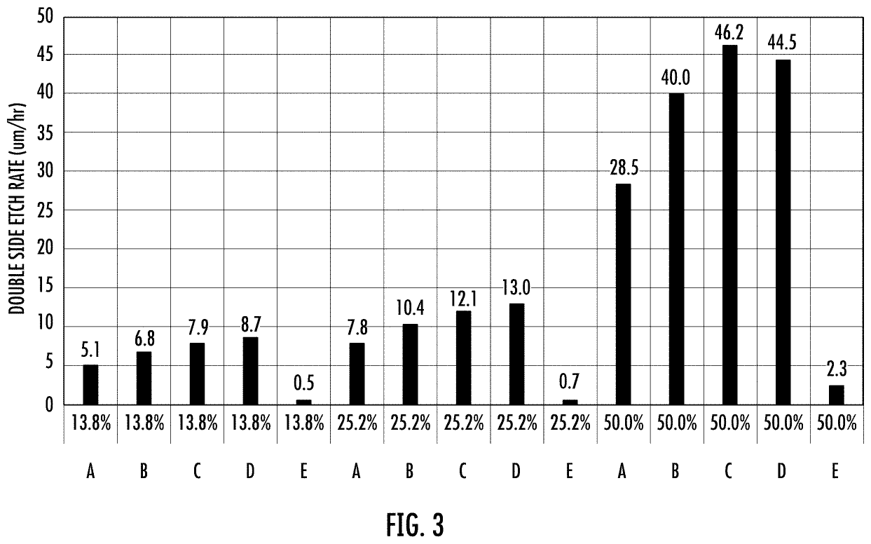

The glass-based substrates were then submerged in an etchant solution for 4 hours, then rinsed in deionized water and dried in air. The thickness of the glass-based substrates was measured by micrometer before and after the etching. The etchant solutions were NaOH aqueous solutions with concentrations of 13.8 wt % at 99° C., 25.2 wt % at 101.5° C., and 50 wt % at 115° C. The resulting etch rates are shown in FIG. 3. As indicated in FIG. 3, the glass ceramic substrate had an etch rate that was an order of magnitude slower than the glass-substrates.

### Example 2

50 mm square glass samples were formed from composition A from Table I having a thickness of 1 mm. The samples were then subjected to the blasting conditions in Table II, utilizing SiC abrasive particles to form abraded samples.

TABLE II

| Condition | 1 | 2 | 3 | 4 |
|---|---|---|---|---|
| Particle | 320 | 320 | 600 | 600 |
| Size (mesh) | | | | |
| Nozzle | 4 | 4 | 4 | 4 |
| Distance (inch) | | | | |
| Angle | 0° | 45° | 0° | 45° |
| Time (min) | 4 | 4 | 4 | 4 |

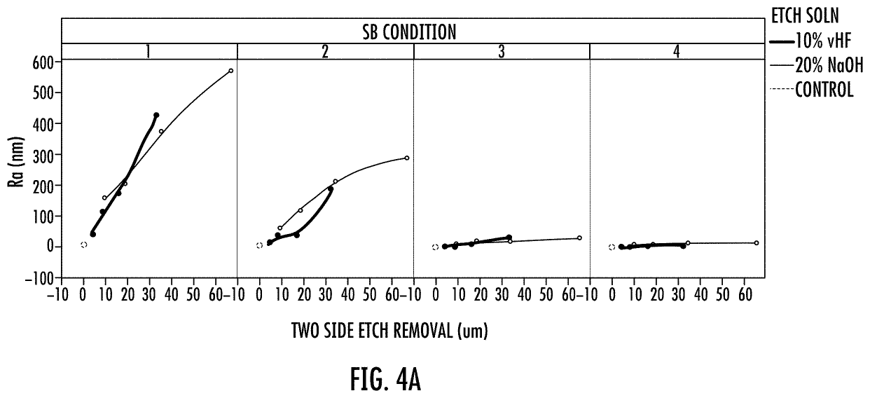

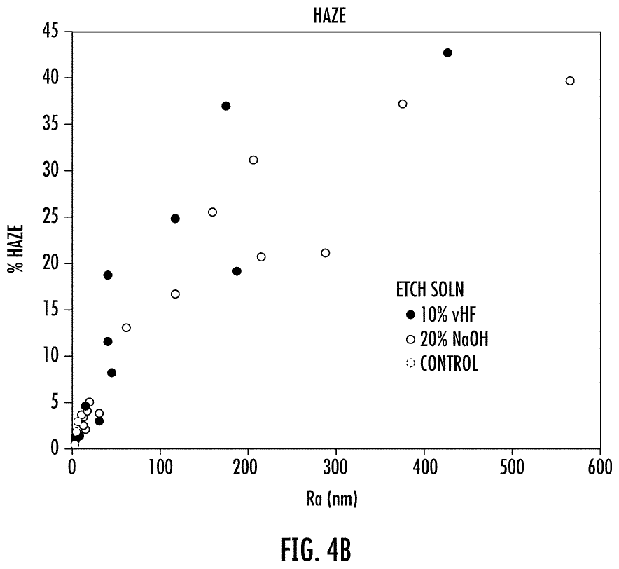

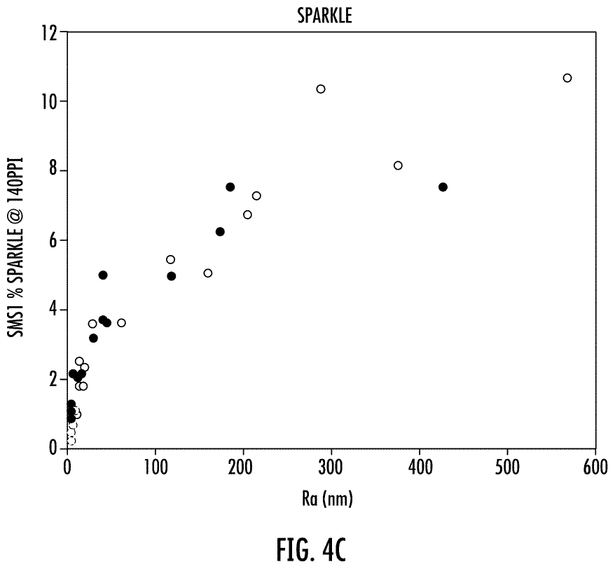

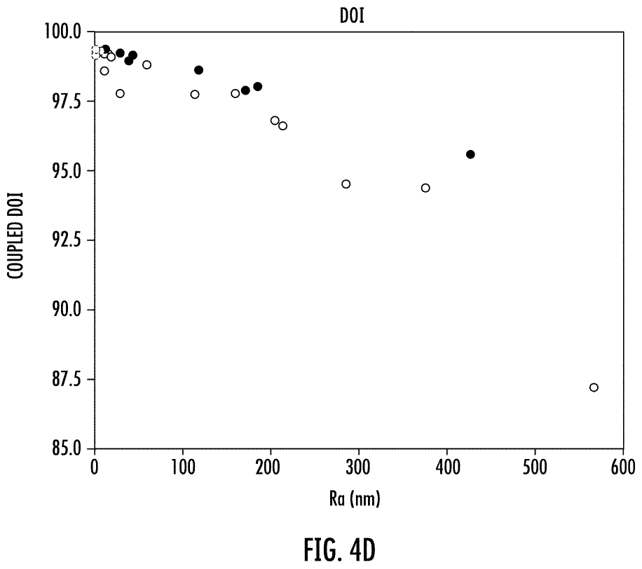

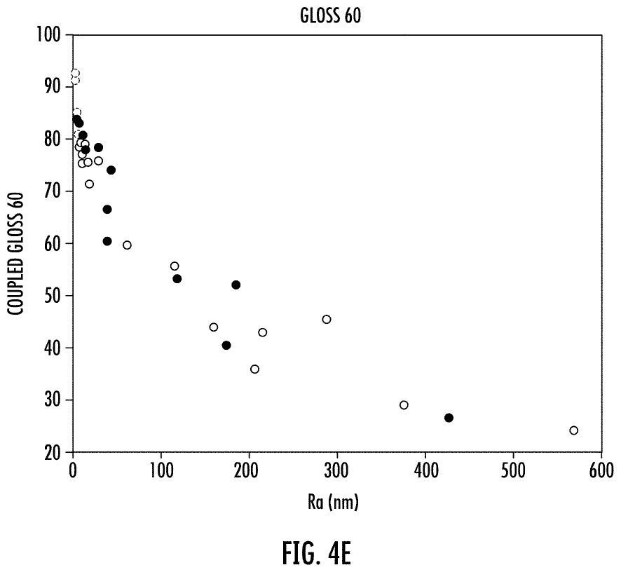

The abraded samples were then etched with aqueous solutions containing 13.8 wt % NaOH at a temperature of 99° C. for time periods of 55 min, 115 min, 247 min, and 370 min. Abraded samples were also etched with aqueous solutions containing 5 wt % HF at room temperature for time periods of 1.4 min, 2.8 min, 5.6 min, and 12.2 min. The etched samples were then analyzed to determine surface roughness, thickness of material removed, DOI, gloss 60°, haze, and sparkle at 140 ppi as described herein. The resulting measurements are summarized in FIGS. 4A-4E. As shown in FIG. 4A, the NaOH samples developed surface roughness in the same manner as the HF samples, and surface roughness correlated with haze, sparkle, DOI, and gloss 60° in a similar manner for the NaOH samples and the HF samples as shown in FIGS. 4B-4E.

### Example 3

50 mm square glass samples were formed from composition A from Table I having a thickness of 1 mm. The samples were abraded and then etched with etchant solutions as described in Table III.

TABLE III

| | NaOH | | | | HF | | | |
|---|---|---|---|---|---|---|---|---|
| Sample | 1 | 2 | 3 | 4 | 1 | 2 | 3 | 4 |
| Concentration (wt %) | 13.8 | 13.8 | 13.8 | 13.8 | 5 | 5 | 5 | 5 |
| Temperature (° C.) | 99 | 99 | 99 | 99 | 20 | 20 | 20 | 20 |
| Etch Time (min) | 55 | 115 | 247 | 370 | 1.4 | 2.8 | 5.6 | 12.2 |
| Gloss 60° (GU) | 18.5 | 18.4 | 23.6 | 31.3 | 15.1 | 16.9 | 26.9 | 37.1 |
| Haze (%) | 61.1 | 48.1 | 30.8 | 21.7 | 63.9 | 45.9 | 26.6 | 17.4 |
| DOI (%) | 92.0 | 85.5 | 79.7 | 80.0 | 85.9 | 81.2 | 81.9 | 81.5 |
| PPD (%) | 2.65 | 3.23 | 4.01 | 4.71 | 2.43 | 3.26 | 4.21 | 4.99 |
| Surface Roughness (μm) | 0.280 | 0.314 | 0.321 | 0.258 | 0.347 | 0.370 | 0.300 | 0.216 |

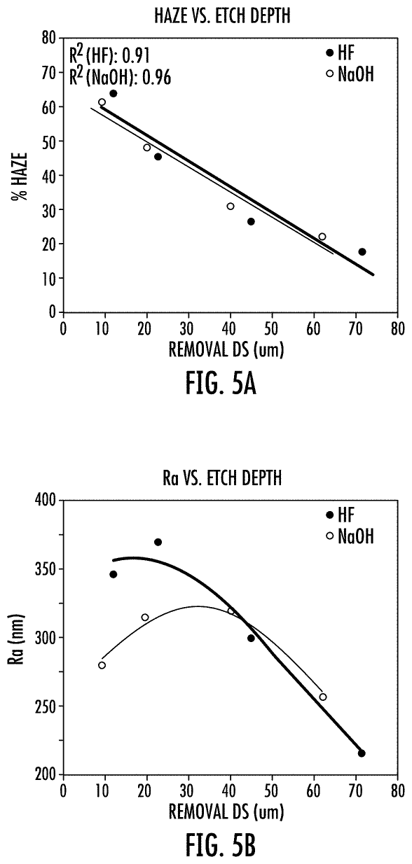

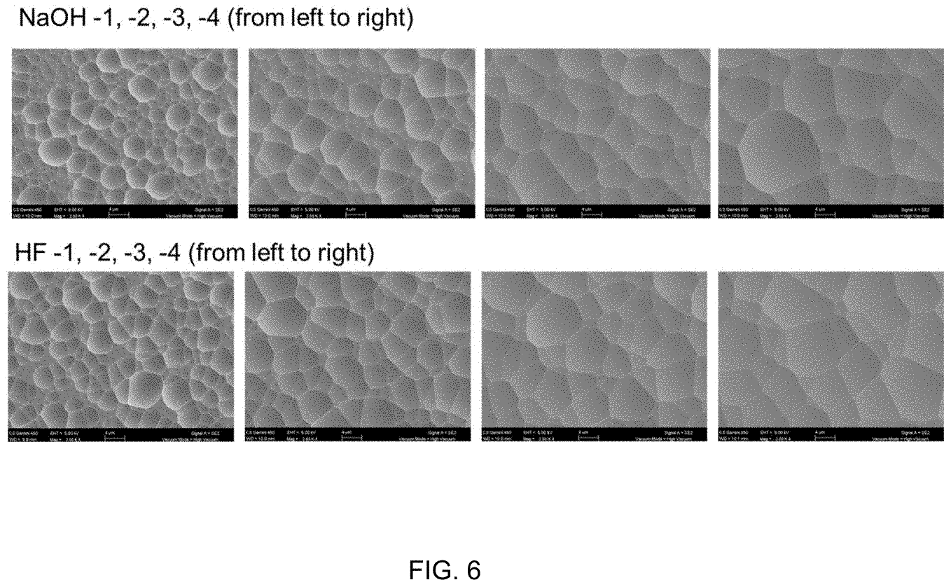

The etched samples were then analyzed to determine surface roughness, thickness of material removed, DOI, gloss 60°, haze, and sparkle at 140 ppi as described herein. The resulting measurements are summarized in Table III and FIGS. 5A do 5B. As shown in FIGS. 5A and 5B, the NaOH samples developed surface roughness and haze in the same manner as the HF samples. FIG. 6 includes scanning electron micrographs for each sample, illustrating that the surface morphology, including feature size and distribution, was similar between the NaOH and HF samples characterized by comparable thicknesses of material removed.

### Example 4

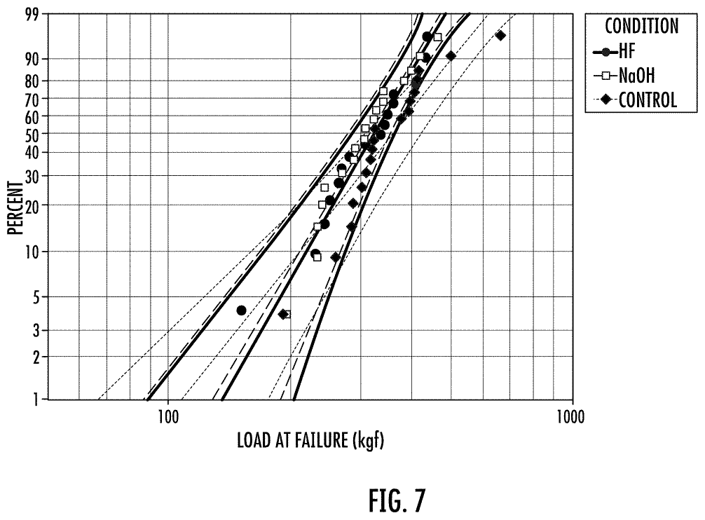

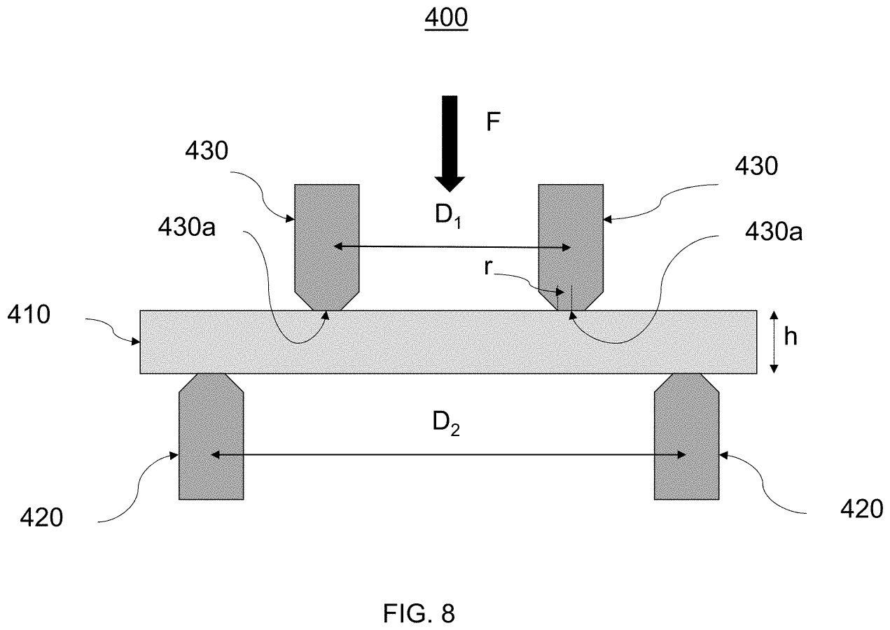

50 mm square glass samples were formed from composition A from Table I having a thickness of 1 mm. The samples were abraded and then etched with an etchant solution containing 13.8 wt % NaOH at a temperature of 99° C. for a time period of 217 min or 5 wt % HF at room temperature for a time period of 13 min. The etched samples and control samples that were not abraded or etched were ion exchanged in a molten salt bath having a temperature of 390° C. containing 60 wt % KNO₃ and 40 wt % NaNO₃ for a time period of 66 min. The ion exchanged glass samples exhibited compressive stresses of about 364 MPa and a depth of potassium ion layer of about 11 μm. The ion exchanged glasses were then subjected to a ring-on-ring (ROR) strength test, with the results shown in FIG. 7. The NaOH-etched samples, HF-etched samples, and control samples have no statistical difference in ROR strength.

For the ROR test, a sample is placed between two concentric rings of differing size to determine equibiaxial flexural strength (i.e., the maximum stress that a material is capable of sustaining when subjected to flexure between two concentric rings), as shown in FIG. 7. In the ROR configuration 400, the glass-based article 410 is supported by a support ring 420 having a diameter D2. A force F is applied by a load cell (not shown) to the surface of the glass-based article by a loading ring 430 having a diameter D1.

The ratio of diameters of the loading ring and support ring D1/D2 may be in a range from 0.2 to 0.5. In some embodiments, D1/D2 is 0.5. Loading and support rings 130, 120 should be aligned concentrically to within 0.5% of support ring diameter D2. The load cell used for testing should be accurate to within ±1% at any load within a selected range. Testing is carried out at a temperature of 23±2° C. and a relative humidity of 40±10%.

For fixture design, the radius r of the protruding surface of the loading ring 430 is in a range of h/2≤r≤3h/2, where h is the thickness of glass-based article 410. Loading and support rings 430, 420 are made of hardened steel with hardness HRc>40. ROR fixtures are commercially available.

The intended failure mechanism for the ROR test is to observe fracture of the glass-based article 410 originating from the surface 430a within the loading ring 430. Failures that occur outside of this region—i.e., between the loading ring 430 and support ring 420—are omitted from data analysis. Due to the thinness and high strength of the glass-based article 410, however, large deflections that exceed ½ of the specimen thickness h are sometimes observed. It is therefore not uncommon to observe a high percentage of failures originating from underneath the loading ring 430. Stress cannot be accurately calculated without knowledge of stress development both inside and under the ring (collected via strain gauge analysis) and the origin of failure in each specimen. ROR testing therefore focuses on peak load at failure as the measured response.

The strength of glass-based article depends on the presence of surface flaws. However, the likelihood of a flaw of a given size being present cannot be precisely predicted, as the strength of glass is statistical in nature. A probability distribution can therefore be used as a statistical representation of the data obtained.

### Example 5

50 mm square glass samples were formed from composition A from Table I having a thickness of 1 mm. The samples were abraded and then etched with an etchant solution containing 13.8 wt % NaOH at a temperature of 99° C. for a time period of 217 min or 5 wt % HF at room temperature for a time period of 13 min. The HF etching was performed only on one side, while the NaOH etching was conducted on both sides of the samples. The etched samples were ion exchanged in a molten salt bath having a temperature of 390° C. containing 60 wt % KNO₃ and 40 wt % NaNO₃ for a time period of 66 min. The ion exchanged glass samples exhibited compressive stresses of about 364 MPa and a depth of potassium ion layer of about 11 μm.

TABLE IV

| Etchant | NaOH | HF |
|---|---|---|
| Gloss 60° (GU) | 23.5 | 23.3 |
| Haze (%) | 31.8 | 32.5 |
| Diffusion (%) | 43.0 | 42.1 |
| Clarity | 63.7 | 64.0 |
| DOI (%) | 78.7 | 79.4 |
| PPD (%) | 3.90 | 3.92 |
| Surface | 0.325 | 0.333 |
| Roughness (μm) | | |

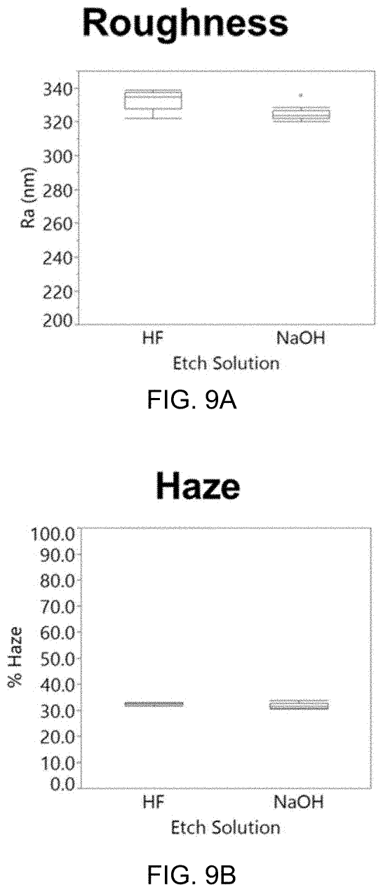

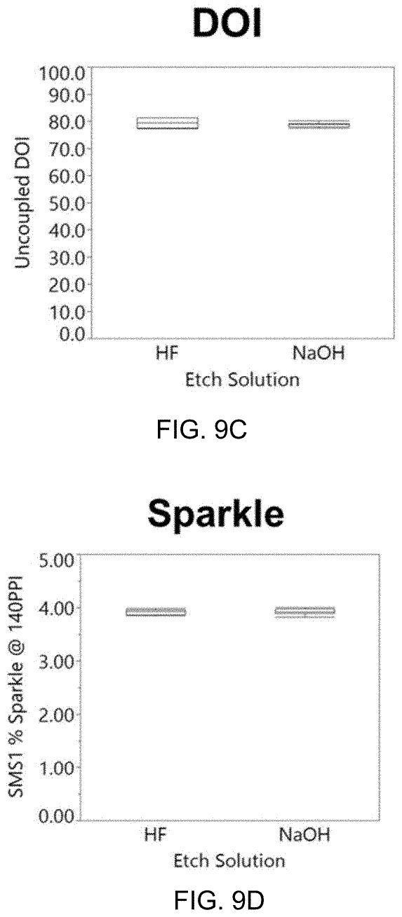

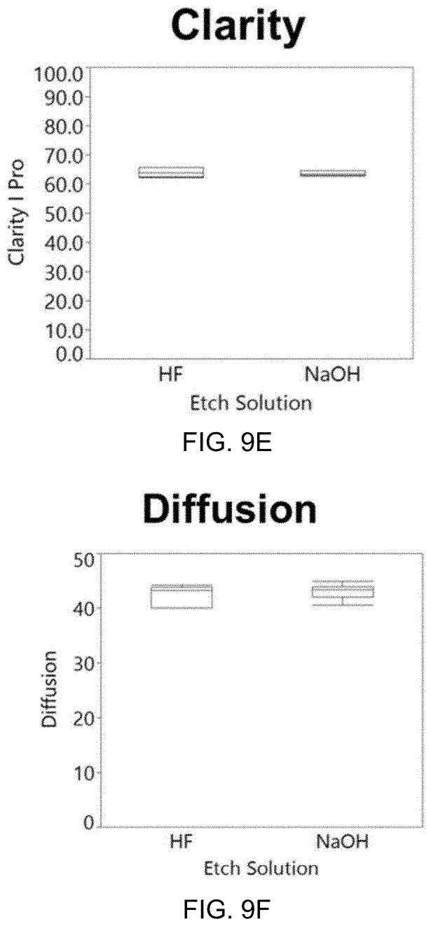

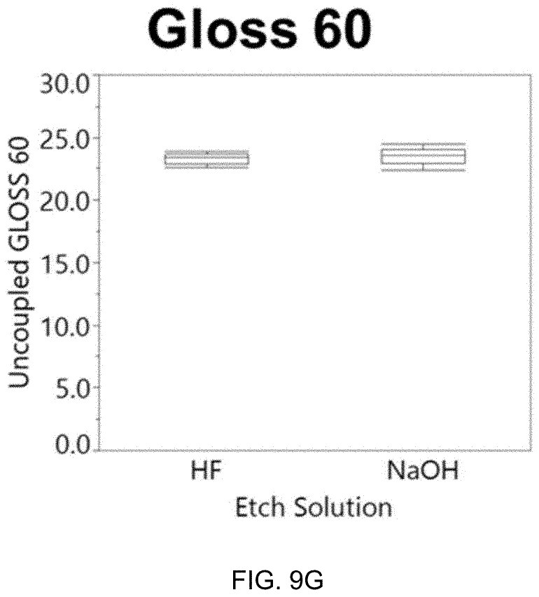

The surface roughness, thickness of material removed, DOI, gloss 60°, haze, and sparkle at 140 ppi were determined as described herein. The clarity was measured using a Haze-gard Transparency Transmission Haze Meter. As demonstrated in Table IV, the NaOH-etched and HF-etched samples exhibited similar optical properties and surface roughness. The measured properties are also reported in FIGS. 9A-9G.

### Example 6

100 mm square glass samples were formed from composition A from Table I having a thickness of 1 mm. The samples were abraded and then etched with an etchant solution containing 13.8 wt % NaOH at a temperature of 99° C. for a time period of 217 min or 5 wt % HF at room temperature for a time period of 13 min. The etching was performed either on one side (single) or both sides (double). All etched samples exhibited a haze of about 30%. The etched samples were ion exchanged in a molten salt bath having a temperature of 390° C. containing 60 wt % KNO₃ and 40 wt % NaNO₃ for a time period of 66 min, which is referred to herein as a low central tension (CT) condition. The low CT ion exchanged glass samples exhibited compressive stresses of about 364 MPa and a depth of potassium ion layer of about 11 μm. Identical samples were ion exchanged in a molten salt bath having a temperature of 410° C. containing 100 wt % KNO₃ for a time period of 6 hours, which is referred to herein as a standard ion exchange condition. The standard ion exchanged glass samples exhibited compressive stresses of about 820 MPa to about 864 MPa and a depth of potassium ion layer of about 44.2 μm. The ion exchanged samples were then measured for warp as described herein. The warp measurements are reported in Table V.

TABLE V

| | | | | Warp TIR (μm) | | |
|---|---|---|---|---|---|---|
| Sample | Etchant | Etching | IOX | pre-IX | post-IX | Change |
| H1 | HF | Single | STD | 19.50 | 79.99 | 60.50 |
| H2 | HF | Single | STD | 17.61 | 69.70 | 52.09 |
| H4 | HF | Double | STD | 17.54 | 46.20 | 28.65 |
| N1 | NaOH | Double | STD | 17.61 | 23.07 | 5.46 |
| N2 | NaOH | Double | STD | 22.19 | 26.03 | 3.84 |
| H3 | HF | Single | low CT | 22.41 | 29.89 | 7.48 |
| H5 | HF | Single | low CT | 24.58 | 28.65 | 4.07 |
| N9N2 | NaOH | Double | low CT | 17.34 | 19.08 | 1.75 |
| N13 | NaOH | Double | low CT | 13.82 | 16.20 | 2.38 |

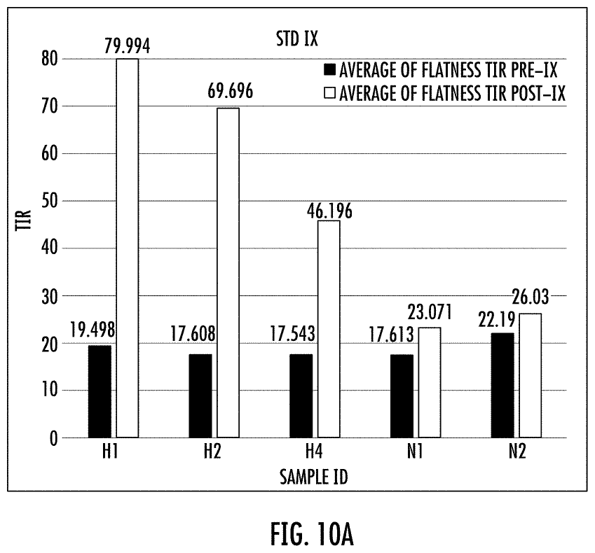

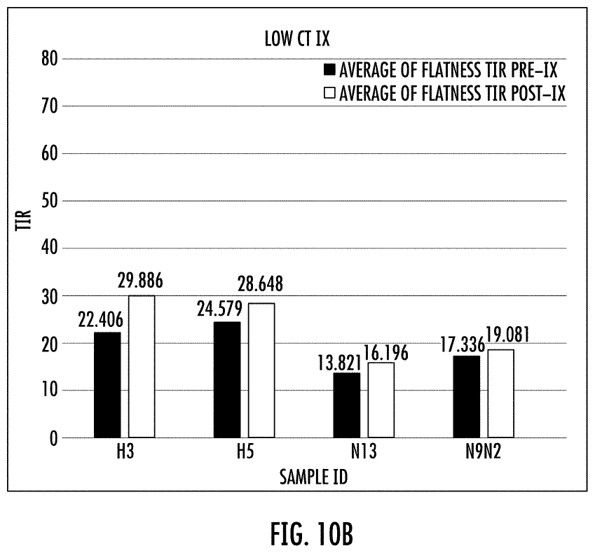

As shown in Table V, the double side NaOH etched low CT samples exhibited the lowest warp. The results are shown in graphical form in FIGS. 10A and 10B. In general, the low CT ion exchanged samples exhibited less change in warp than the standard ion exchanged samples, and the double etched samples exhibited less change in warp than the single etched samples.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method, comprising:
abrading a surface of a glass-based substrate to form an abraded surface by propelling abrasive particles against the surface, wherein the glass-based substrate comprises an alkali aluminosilicate;
etching the abraded surface with an etchant for a time period of greater than or equal to 15 minutes to less than or equal to 400 minutes to form an etched glass-based substrate, wherein the etchant is an aqueous hydroxide solution with a hydroxide concentration of greater than or equal to 5 wt % to less than or equal to 60 wt %; and
ion exchanging the etched glass-based substrate with a molten salt bath to form a glass-based article, wherein the glass-based article comprises a compressive stress layer extending from a surface of the glass-based article to a depth of compression and has a haze of less than or equal to 50%.

2. The method of claim 1, wherein the etching occurs at a surface removal rate of less than or equal to 60 μm/hour.

3. The method of claim 1, wherein the etchant is at a temperature of greater than or equal to 90° C. to less than or equal to 140° C.

4. The method of claim 1, wherein the etchant comprises NaOH, KOH, or combinations thereof.

5. The method of claim 1, wherein the etching time period is greater than or equal to 15 minutes to less than or equal to 300 minutes.

6. The method of claim 1, wherein the etching removes greater than or equal to 5 μm to less than or equal to 50 μm from the abraded surface.

7. The method of claim 1, wherein no mask is utilized during the etching.

8. The method of claim 1, wherein the abrasive particles comprise sand, Al₂O₃, SiC, SiO₂, and combinations thereof.

9. The method of claim 1, wherein the abrasive particles have a particle size of greater than or equal to 2000 grit to less than or equal to 200 grit.

10. The method of claim 1, wherein the abrasive particles have a particle size of greater than or equal to 2000 grit to less than or equal to 1200 grit.

11. The method of claim 1, wherein the abrasive particles are propelled by a fluid medium at a pressure of greater than or equal to 5 psi to less than or equal to 30 psi.

12. The method of claim 1, wherein the abrasive particles are propelled from a nozzle at a distance from the surface of greater than or equal to 5 cm to less than or equal to 20 cm.

13. The method of claim 1, wherein the abrasive particles are propelled against the surface at an angle from orthogonal to the surface of greater than or equal to 0° to less than or equal to 60°.

14. The method of claim 1, wherein the glass-based article has a haze of greater than or equal to 3% to less than or equal to 40%.

15. The method of claim 1, wherein the glass-based article has a distinctness of image of less than or equal to 92%.

16. The method of claim 1, wherein the glass-based article has a pixel power deviation at 140 ppi of less than or equal to 5%.

17. The method of claim 1, wherein the glass-based article has a gloss 60° value of less than or equal to 40%.

18. The method of claim 1, wherein the glass-based article has a surface roughness Ra of greater than or equal to 100 nm to less than or equal to 400 nm.

19. The method of claim 1, wherein the glass-based article has a warp of less than or equal to 500 μm.

20. The method of claim 1, wherein the glass-based article satisfies:
$$W \leq 0.5 \frac{{d}^{2}}{470321.6 {mm}^{2}}$$
wherein W is warp in mm, and d is a diagonal measurement of the glass-based article in mm.
